(19) United States
(12) Patent Application Publication
(10) Pub. No.: US 2012/0103425 A1
(43) Pub. Date: May 3, 2012

(54) Flow Meter With Improved Thermal Stability And Methods Of Use

(75) Inventors: Joseph Yudovsky, Campbell, CA (US); Dennis L. DeMars, Santa Clara, CA (US)

(73) Assignee: Applied Materials, Inc., Santa Clara, CA (US)

(21) Appl. No.: 13/189,953

(22) Filed: Jul. 25, 2011

Related U.S. Application Data
(60) Provisional application No. 61/408,009, filed on Oct. 29, 2010.

(51) Int. Cl. F15D 1/00

(52) U.S. Cl. 137/2; 137/551

(57) ABSTRACT

Devices and methods for controlling flow to a processing chamber are disclosed. The devices comprise a flow meter, an inlet tube in fluid communication with the flow meter, an outlet tube in fluid communication with the outlet of the flow meter, and thermal insulation encompassing at least a portion of the flow meter, at least a portion of the inlet tube and at least a portion of the outlet tube.

### CROSS-REFERENCE TO RELATED APPLICATIONS

This application claims the benefit of U.S. Patent Application No. 61/408,009, filed on Oct. 29, 2010.

### BACKGROUND

Embodiments of the invention generally relate to semiconductor processing apparatuses. More specifically, embodiments of the invention relate to methods and apparatus for improving the mass flow uniformity of a fluid.

The continued reduction in size of semiconductor devices is dependent upon more precise control of, for instance, the flow rate of process gases delivered to a semiconductor processing chamber. Typically, the process gases are provided utilizing a flow meter for each process gas being delivered.

In many semiconductor processes, a flow meter controls the amount of fluid being delivered to a vaporizer. Two sensors measure the temperature across a thermal element. For examples, the two sensors may measure a drop in temperature as the liquid flows through a cold plate. The change in temperature characterizes the mass of flowing liquid, i.e., faster flow will show a smaller change in temperature than a slower flow.

Flow meters are affected by the environmental conditions. A zero offset procedure compensates for the temperature gradient in the flow meter body caused by the environment. However, with significant change in the thermal conditions outside the flow meter, the temperature gradient also changes and causes incorrect flow measurements. Therefore, there is a need in the art for systems and methods to mitigate the affect of the environment on the temperature gradient in a flow meter.

### SUMMARY

One or more embodiments of the invention are directed to devices for controlling flow to a processing chamber. The devices comprise a flow meter comprising an inlet port, an outlet port, a first temperature sensor, a second temperature sensor and a thermal element. The thermal element is disposed between the first temperature sensor and the second temperature sensor to heat or cool a fluid flowing through the device. An inlet tube for fluid communication with a fluid source is connected to and in fluid communication with the inlet port of the flow meter. An outlet tube is connected to and in fluid communication with the outlet port of the flow meter to deliver fluid to the chamber. Thermal insulation encompasses at least a portion of the flow meter, at least a portion of the inlet tube and at least a portion of the outlet tube to isolate the device from ambient temperature variations between the inlet tube and the outlet tube thereby reducing variations in flow rate resulting from the temperature variations.

In detailed embodiments, the thermal insulation provides sufficient thermal resistance to substantially thermally isolate the inlet port, outlet port, first temperature sensor, second temperature sensor and thermal element of the flow meter from ambient conditions.

The thermal insulation can be made from any suitable material. In detailed embodiments, the thermal insulation comprises silicone rubber. In some embodiments, the thermal insulation encompassing at least a portion of the flow meter is at least about 5 mm thick. In one or more embodiments, the thermal insulation extends along a length of the outlet tube in the range of about 25 mm to about 150 mm from the outlet of the flow meter. In specific embodiments, the thermal insulation extends along a length of the inlet tube in the range of about 25 mm to about 150 mm from the inlet port of the flow meter. In some embodiments, the thermal insulation encompasses at least a portion of the flow meter comprising the first temperature sensor, the second temperature sensor and the thermal element.

The thermal element can be any element suitable to heat/cool a fluid. In detailed embodiments, the thermal element is a Peltier device.

In one or more embodiments, a calculated mass flow is more accurate than a calculated mass flow from a substantially similar device without the thermal insulation under similar conditions. In detailed embodiments, a temperature change due to fluid flow through the thermal element is at least about 2 times greater than temperature variation due to ambient temperature.

Additional embodiments of the invention are directed to a semiconductor process chamber comprising the device for controlling flow, wherein the device is in fluid communication with a fluid supply.

Further embodiments of the invention are directed to methods of processing a substrate in a processing chamber. A fluid is flowed through a thermally insulated inlet tube into an inlet port of a thermally isolated flow meter. A first temperature of the fluid is measured. The fluid is flowed through a thermal element to cause a temperature change in the fluid. A second temperature of the fluid is measured. The fluid is flowed out an outlet of the thermally isolated flow meter into a thermally isolated outlet tube.

In detailed embodiments, the inlet tube, outlet tube and flow meter are at least partially insulated with a silicone rubber insulation. In specific embodiments, the silicone rubber insulation is at least about 5 mm thick.

In some embodiments, the thermal element causes the temperature of the fluid to decrease. In some embodiments, the thermal element causes the temperature of the fluid to increase.

One or more embodiments further comprise determining the difference between the first temperature and the second temperature and calculating a mass flow from the temperature difference.

### BRIEF DESCRIPTION OF THE DRAWINGS

So that the manner in which the exemplary embodiments of the present invention are attained and can be understood in detail, a more particular description of the invention, briefly summarized above, may be had by reference to the embodiments thereof which are illustrated in the appended drawings. It is to be appreciated that certain well known processes are not discussed herein in order to not obscure the invention.

FIG. 1 shows a cross-section of a device for controlling flow in accordance with one or more embodiments of the invention.

It is contemplated that elements and features of one embodiment may be beneficially incorporated in other embodiments without further recitation. It is to be noted, however, that the appended drawings illustrate only exemplary embodiments of this invention and are therefore not to be considered limiting of its scope, for the invention may admit to other equally effective embodiments.

### DETAILED DESCRIPTION

Before describing several exemplary embodiments of the invention, it is to be understood that the invention is not limited to the details of construction or process steps set forth in the following description. The invention is capable of other embodiments and of being practiced or being carried out in various ways.

As used in this specification and the appended claims, the term “flow meter” may be used interchangeably with “liquid flow meter” and “fluid flow meter”. The term “liquid” may be used interchangeably with “fluid”. A “fluid” can be any suitable state of matter including solids, liquids and gases and is not intended to be limited to liquids only. Where the term “liquid” is used, gases or solids can be substituted.

In ideal conditions, the temperature measurements across the thermal element in a flow meter with zero flow will be equal. However, ambient conditions can cause a change in the temperature across the thermal element, even under zero flow. This temperature gradient can result in a calculated flow, causing the flow meter to be skewed. Therefore, it is common to calibrate a flow meter for a given fluid to account for this temperature gradient. However, even after calibration, changes in ambient conditions can cause an uncompensated temperature gradient, resulting in an incorrect flow measurement. It has been observed that the flow rate measured by a flow meter can be impacted by localized heat or changes in air flow. The flow rate can deviate by 3%-15% with a 15° C. change in the ambient conditions. Flow meters can take about two hours to stabilize after a temperature change. This is compounded in environments where the ambient temperature may change more often or with larger localized temperature deviations. An unstable flow meter can result in an unstable process and/or variations between process chambers.

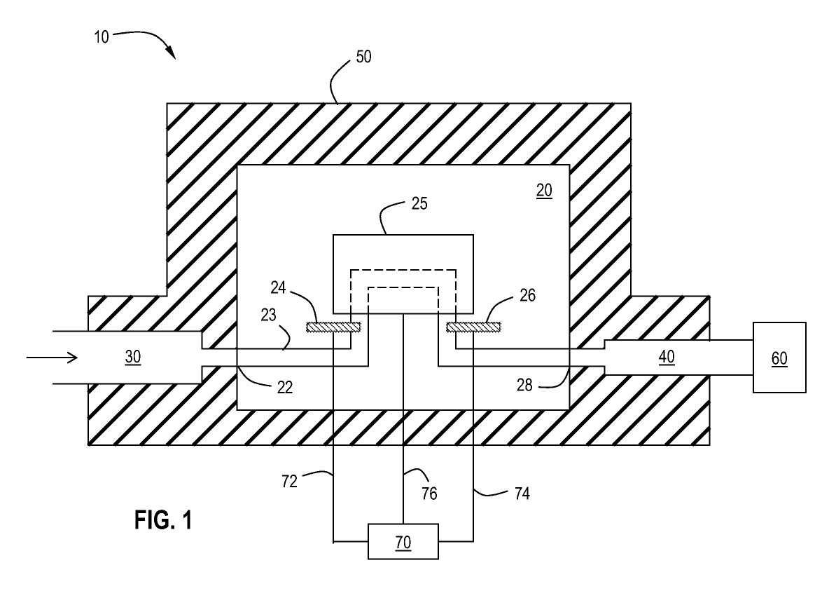

Accordingly, a specific aspect of the invention relates to use of thermal insulation to provide an isothermal environment for a flow meter. Accordingly, one or more embodiments of the invention are directed to devices for controlling flow to a deposition chamber. Referring to FIG. 1, the device 10 comprises a flow meter 20, an inlet tube 30, an outlet tube 40 and thermal insulation 50. The flow meter 20 comprises an inlet port 22 for receiving a flow of liquid. The liquid flows in the inlet port 22 and along a tube 23. The tube 23 directs the flow past a first temperature sensor 24, through a thermal element 25 and past a second temperature sensor 26 before flowing out of the outlet port 28.

Suitable temperature sensors are any which are capable of accurately measuring temperature in the liquid being measured. Examples of suitable temperature sensors include, but are not limited to, thermistors and thermocouples. The first temperature sensor 24 and the second temperature sensor 26 can be the same type of temperature sensors or different types of temperature sensors.

The thermal element 25 is capable of heating or cooling a fluid flowing through the thermal element 25. The thermal element 25 is any type of system or device which is capable of heating and/or cooling. Suitable thermal elements include, but are not limited to, Peltier or thermoelectric devices, thermodes, pyroelectric devices, liquid heating or cooling, air conditioners, heat exchangers and combinations thereof. In specific embodiments, the thermal element 25 is a Peltier device.

An inlet tube 30 for fluid communication with a fluid source is in fluid communication with the inlet port 22 of the flow meter 20. The inlet tube 30 shown in FIG. 1 has a larger diameter than the inlet port 22 of the flow meter 20. The diameter of the inlet tube 30 is decreased to connect to the flow meter 20, but does not necessarily need to be. The inlet tube 30 can be of the same dimensions as the inlet port 22 and tube 23 or can be of different dimensions. As the skilled artisan will readily understand, the inlet tube 30 is in fluid communication with an appropriate liquid or gas supply (not shown). The liquid or gas supply can be any suitable reactants, precursors or carriers used in the processing of semiconductors, for example the formation of films or layers by chemical vapor deposition, atomic layer deposition and other processes. Suitable precursors can in include, but are not limited to silicon-containing precursors, germanium-containing precursors, and carbon-containing precursors. Suitable carriers include hydrogen, nitrogen and other inert gases. Other suitable gases can include oxygen and metallorganic precursors for forming films or layers such as titanium, tungsten, hafnium, indium, aluminum, arsenic, gallium, phosphorous, etc.

An outlet tube 40 is connected to and in fluid communication with the outlet port 28 of the flow meter 20 to deliver fluid to the processing chamber 60. The outlet tube 40 shown in FIG. 1 has a larger diameter than the outlet port 28 of the flow meter 20, but this is not necessary. The outlet tube 40 can have a larger, smaller or equal dimensions as the outlet port 28 of the flow meter 20. The inlet tube 30 and outlet tube 40 can also have different dimensions.

The flow meter 20 can be used to calculate a mass flow of a fluid by measurement of the temperature difference between the first temperature sensor 24 and the second temperature sensor 26, based on the temperature of the thermal element 25. If the thermal element 25 is kept at a temperature below the temperature of liquid entering the LFM, the temperature at the second temperature sensor 26 will be lower than the temperature at the first temperature sensor 24. This difference in temperature is employed to calculate the length of time that the liquid resided in the thermal element 25. With all else being equal, the lower the difference in temperature, the faster the flow, as the liquid has not spent as much time in the thermal element 25. This difference in temperature can be dependent on many factors, including the flow rate and the heat capacity of the liquid. These parameters are known to those skilled in the art and are not discussed further.

It has been observed that the environment of the flow meter 20 affects the accuracy of the measurement. In a typical flow meter 20, calibration results in a zero offset correction for the first temperature sensor 24 and the second temperature sensor 26. In use in a thermally variable environment, the zero offset is not consistent at various temperatures. For example, a typical system flowing tetrakis(diethylamino)hafnium (TDEAH) with a set point of 5 mg/min can have an actual flow of 5.2 mg/min at 24° C. and an actual flow rate of 7.0 mg/min at 30° C. This small difference in temperature can have a dramatic result on the actual flow rate. The inventors have discovered that insulating the flow meter 20 does not provide a sufficiently stable environment to counteract these environmentally induced temperature gradients.

Thermal insulation 50 encompasses at least a portion of the flow meter 20, at least a portion of the inlet tube 30 and at least a portion of the outlet tube 40 to isolate the device 10 from ambient temperature variations between the inlet tube 30 and the outlet tube 40 thereby reducing variations in a material deposition rate resulting from the temperature variations. As used in this specification and the appended claims, the term “encompass” means that the thermal insulation 50 at least partially surrounds the subject component. The thermal insulation 50 of one or more embodiment is sufficient to prevent ambient conditions from causing an unexpected difference in the temperature gradient between the first temperature sensor 24 and the second temperature sensor 26. In detailed embodiments, the thermal insulation 50 provides sufficient thermal resistance to substantially thermally isolate the inlet port 22, outlet port 28, first temperature sensor 24, second temperature sensor 26 and thermal element 25 of the flow meter 20 from ambient conditions. As used in this specification and the appended claims, the term “substantially thermally isolate” means that temperature gradient between the first temperature sensor 24 and the second temperature sensor 26 will result in a calculated flow that is within about 10% of the actual value, or within about 5% of the actual value, or within about 1% of the actual value. In detailed embodiments, at least a portion of the flow meter 20 comprises the first temperature sensor 24, the second temperature sensor 26 and the thermal element 25.

In conventional devices, the ambient conditions cause a temperature variation of sufficient magnitude, compared to the difference in temperature due to flow through the thermal element 25, that the calculated flow rates are affected. In one or more embodiments, the temperature variation due to ambient temperature is lower than the temperature change due to the flow of fluid through the thermal element 25, as measured by the first temperature sensor 24 and the second temperature sensor 26. This is analogous to a signal-to-noise ratio where the temperature variation from flow through the thermal element 25 is the signal and the temperature variation due to the ambient environment is the noise. In detailed embodiments, the temperature change due to fluid flow through the thermal element 25 (signal) is at least about 2 times greater than the temperature variation due to ambient temperature (noise). In some embodiments, the temperature change due to fluid flow through the thermal element 25 (signal) is at least about 3 times greater than the temperature variation due to ambient temperature (noise). In specific embodiments, the temperature change due to fluid flow through the thermal element 25 is at least about 10 times greater than the temperature variation due to ambient temperature. In various embodiments, the temperature change due to fluid flow through the thermal element 25 is greater than the temperature variation due to ambient temperature by at least about 4, 5, 6, 7, 8, or 9 times.

The thermal insulation 50 can be made from any suitable insulating material. Examples include, but are not limited to, silicone rubber, fiberglass, asbestos, polystyrene, Thinsulate®, vermiculatie, neoprene, aerogels, spray foams, rigid panels, loose fill materials, vacuums and combinations thereof. The pervious list of suitable thermal insulators is merely illustrative and should not be taken as limiting the scope of the invention. In specific embodiments, the thermal insulation 50 comprises silicone rubber.

The thermal insulation 50 may be specified by R-values. An R-value is a measure of the thermal resistance of the material and is the ratio of the temperature difference across the insulator and the heat flux through the insulator. Larger R-values indicate a larger differential, i.e., greater insulating ability. In some embodiments, the R-value of the thermal insulation is greater than about 2. In detailed embodiments the R-value of the thermal insulation is greater than about 3, 4, 5, 6, 7, 8, 9, 10, 15, 20, 25, 30, 35, 40, 45 or 50.

The thickness of the insulation 50 is dependent on a number of factors, including, but not limited to, the R-value of the thermal insulation 50 and the size of the flow meter 20. The insulation 50 thickness depends on the thermal gradient the device 10 is exposed to and the R value of the insulation. The insulation 50 isolates the thermally sensitive components inside the device from the thermally different surrounding ambient temperatures. The greater the different in temperature the more insulation is needed. For a specific insulator, the insulation value is generally liner with the thickness. In a detailed embodiment, the thermal insulation 50 encompassing at least a portion of the flow meter is at least about 5 mm thick. In various embodiments, the thermal insulation 50 encompassing at least a portion fo the flow meter 20 is at least about 2 mm, 3 mm, 4 mm, 6 mm, 7 mm, 8 mm, 9 mm or 10 mm thick.

The thermal insulation 50 of some embodiments extends along a length of the outlet tube 40. In one or more embodiments, the thermal insulation 50 extends along a length of the inlet tube. The length of the thermal insulation 50 extending along either or both of the inlet tube 30 and the outlet tube 40 extends in the range of about 25 mm to about 150 mm from the inlet port 22 or outlet port 28 of the flow meter 20, respectively.

In detailed embodiments, the flow rate of a liquid through the flow meter is more accurate than the flow rate of a liquid through a flow meter without the thermal insulation 50. In specific embodiments, the calculated mass flow through the flow meter 20 is more accurate than a calculated mass flow from a substantially similar device without the thermal insulation 50.

The outlet tube 40 can be connected to any suitable apparatus requiring a controlled flow of liquid. In specific embodiments, the liquid flowing in the outlet tube 40 is directed to a processing chamber 60, for example, a semiconductor processing chamber. The processing chamber 60 may include a showerhead (not shown) capable of dispersing the liquid in a controlled manner. In specific embodiments, the processing chamber 60 includes a vaporizer capable of vaporizing the liquid. In detailed embodiments, the semiconductor processing chamber is one or more of a chemical vapor deposition apparatus, a physical vapor deposition apparatus and an atomic layer deposition apparatus to form a layer or a film on a substrate (not shown).

The substrate processed in the processing chamber may be any suitable substrate processed in a processing apparatus. For example, the substrate may be any suitable material to be processed, such as crystalline silicon (e.g., Si<100> or Si<111>), silicon oxide, strained silicon, silicon germanium, doped or undoped polysilicon, doped or undoped silicon wafers, patterned or non-patterned wafers, silicon on insulator (SOI), carbon doped silicon oxides, silicon nitride, doped silicon, germanium, gallium arsenide, glass, sapphire, a display substrate (such as a liquid crystal display (LCD), a flat panel display (FPD), a plasma display, an electro luminescence (EL) lamp display, or the like), a solar cell array substrate (such as a solar cell or solar panel), a light emitting diode substrate (such as an LED, OLED, FOLED, PLED, or the like), an organic thin film transistor, an active matrix, a passive matrix, a top emission device, a bottom emission device, or the like. The substrate may have various dimensions, such as 200 mm or 300 mm diameter wafers, as well as rectangular or square panels.

The processing chamber 60 may be configured, for example, to deposit a layer of material on the substrate, to introduce a dopant to the substrate, to etch the substrate or a material deposited on the substrate, to otherwise treat the substrate, or the like. Such layers deposited on the substrate may include layers for use in a semiconductor device, for example, a metal oxide semiconductor field effect transistor (MOSFET) or a flash memory device. Such layers may include silicon-containing layers, such as polysilicon, silicon nitride, silicon oxide, silicon oxynitride, metal silicide, or alternatively, metal containing layers, such as copper, nickel, gold, or tin containing layers, or metal oxide layers, for example hafnium oxide. Other deposited layers may include, for example, sacrificial layers such as etch stop layers, photoresist layers, hardmask layers, and the like.

The processing chamber 60 may use any suitable process gas and/or process gas mixture (i.e., a fluid or mixture of fluids), for example, to form a layer atop the substrate, to remove material from the substrate, or to otherwise react with material layers exposed upon the substrate, or the like. Such process gases may include silicon-containing gases, such as silane (SiH₄), dichlorosilane (Cl₂SiH₂), or the like; and/or metal-containing gases, such as metalorganics, metal halides or the like. Other process gases may include inert gases, such as helium (He), argon (Ar), nitrogen (N₂), or the like; and/or reactive gases, such as halogen-containing gases, oxygen (O₂), hydrogen fluoride (HF), hydrogen chloride (HCl), hydrogen bromide (HBr), nitrogen trifluoride (NF₃) or the like. Some of these process gases may be cooled in the thermal element 25 or heated in the thermal element 25 depending on the properties of the particular process gas.

Still referring to FIG. 1, a controller 70 may be connected to one or more of the first temperature sensor 24, the second temperature sensor 26 and the thermal element 25. The controller 70 of FIG. 1 is shown in communication with the first temperature sensor 24 through a first connection 72, the second temperature sensor 26 through a second connection 74 and the thermal element 25 through a third connection 76. The controller 70 is capable of receiving signals from the temperature sensors indicative of the temperature of the liquid. Additionally, the controller 70 may send or receive signals to/from the thermal element 25 which can enable the controller to act as a feedback circuit or for control and diagnostics. The controller 70 of detailed embodiments can analyze the difference between the temperature at the first temperature sensor 24 and the second temperature sensor 26 and determine the flow rate in view of the temperature of the thermal element 25. Additionally, the controller 70 may be able to adjust the temperature of the thermal element 25 to produce a larger temperature differential between the first temperature sensor 24 and the second temperature sensor 26 to enhance the accuracy the flow rate calculation.

Additional embodiments of the invention are directed to methods of processing a substrate in a processing chamber. The method comprises flowing from a fluid supplied through a thermally insulated inlet tube 30 into an inlet port 22 of a thermally isolated flow meter 20. The fluid flows along a tube 23 in the flow meter 20 past a first temperature sensor 24 which measures a first temperature of the fluid. The fluid then passes through a thermal element 25 which is capable of causing a change in the temperature of the fluid. The fluid exiting the thermal element 25 passes a second temperature sensor 26 where a second temperature is measured before the fluid passes out an outlet port 28 of the thermally isolated flow meter 20 into a thermally isolated outlet tube 40.

In some embodiments, the thermal element 25 causes the temperature of the fluid to decrease. In some embodiments, the thermal element 25 causes the temperature of the fluid to increase. Detailed embodiments of the invention further comprise determining the difference between the first temperature and the second temperature and calculating a mass flow from the temperature difference.

Reference throughout this specification to “one embodiment,” “certain embodiments,” “one or more embodiments,” “an embodiment,” “one aspect,” “certain aspects,” “one or more embodiments” and “an aspect” means that a particular feature, structure, material, or characteristic described in connection with the embodiment is included in at least one embodiment of the invention. Thus, the appearances of the phrases such as “in one or more embodiments,” “in certain embodiments,” “in one embodiment,” “in an embodiment,” “according to one or more aspects,” “in an aspect,” etc., in various places throughout this specification are not necessarily referring to the same embodiment or aspect of the invention. Furthermore, the particular features, structures, materials, or characteristics may be combined in any suitable manner in one or more embodiments or aspects. The order of description of the above method should not be considered limiting, and methods may use the described operations out of order or with omissions or additions.

It is to be understood that the above description is intended to be illustrative, and not restrictive. Many other embodiments will be apparent to those of ordinary skill in the art upon reviewing the above description. The scope of the invention should, therefore, be determined with reference to the appended claims, along with the full scope of equivalents to which such claims are entitled.

What is claimed is:

1. A device for controlling flow to a processing chamber, the device comprising:
a flow meter comprising an inlet port, an outlet port, a first temperature sensor, a second temperature sensor and a thermal element disposed between the first temperature sensor and the second temperature sensor to heat or cool a fluid flowing through the device;
an inlet tube for fluid communication with a fluid source and connected to and in fluid communication with the inlet port of the flow meter;
an outlet tube connected to and in fluid communication with the outlet port of the flow meter to deliver fluid to the chamber; and
thermal insulation encompassing at least a portion of the flow meter, at least a portion of the inlet tube and at least a portion of the outlet tube to isolate the device from ambient temperature variations between the inlet tube and the outlet tube thereby reducing variations in flow rate resulting from the temperature variations.

2. The device for controlling flow of claim 1, wherein the thermal insulation provides sufficient thermal resistance to substantially thermally isolate the inlet port, outlet port, first temperature sensor, second temperature sensor and thermal element of the flow meter from ambient conditions.

3. The device for controlling flow of claim 1, wherein the thermal insulation comprises silicone rubber.

4. The device for controlling flow of claim 1, wherein the thermal insulation encompassing at least a portion of the flow meter is at least about 5 mm thick.

5. The device for controlling flow of claim 1, wherein the thermal insulation extends along a length of the outlet tube in the range of about 25 mm to about 150 mm from the outlet of the flow meter.

6. The device for controlling flow of claim 1, wherein the thermal insulation extends along a length of the inlet tube in the range of about 25 mm to about 150 mm from the inlet port of the flow meter.

7. The device for controlling flow of claim 1, wherein the thermal element is a Peltier device.

8. The device for controlling flow of claim 1, wherein the thermal insulation encompasses at least a portion of the flow meter comprising the first temperature sensor, the second temperature sensor and the thermal element.

9. The device for controlling flow of claim 1, wherein a calculated mass flow is more accurate than a calculated mass flow from a substantially similar device without the thermal insulation under similar conditions.

10. The device for controlling flow of claim 1, wherein temperature change due to fluid flow through the thermal element is at least about 2 times greater than temperature variation due to ambient temperature.

11. A semiconductor process chamber comprising the device in accordance with claim 1, wherein the device is in fluid communication with a fluid supply.

12. A method of processing a substrate in a processing chamber, the method comprising:
flowing a fluid through a thermally insulated inlet tube into an inlet port of a thermally isolated flow meter;
measuring a first temperature of the fluid;
flowing the fluid through a thermal element to cause a temperature change in the fluid;
measuring a second temperature of the fluid; and
flowing the fluid out an outlet of the thermally isolated flow meter into a thermally isolated outlet tube.

13. The method of claim 12, wherein the inlet tube, outlet tube and flow meter are at least partially insulated with silicone rubber insulation.

14. The method of claim 13, wherein the silicone rubber insulation is at least about 5 mm thick.

15. The method of claim 12, wherein the thermal element causes the temperature of the fluid to decrease.

16. The method of claim 12, wherein the thermal element causes the temperature of the fluid to increase.

17. The method of claim 12, further comprising determining the difference between the first temperature and the second temperature and calculating a mass flow from the temperature difference.

18. The method of claim 11 wherein the thermal element is a Peltier device.

19. The method of claim 11, wherein the thermal element is a heat exchanger.

20. The method of claim 11, wherein the thermal element is a thermoelectric device.
